(19) United States
(12) Patent Application Publication
(10) Pub. No.: US 2024/0198149 A1
(43) Pub. Date: Jun. 20, 2024

(54) THERMAL-REDUCING HYDRAULIC APPARATUS

(71) Applicant: Jeremy Ryan Twombly, Attleboro, MA (US)

(72) Inventor: Jeremy Ryan Twombly, Attleboro, MA (US)

(21) Appl. No.: 18/538,629

(22) Filed: Dec. 13, 2023

Related U.S. Application Data
(60) Provisional application No. 63/387,601, filed on Dec. 15, 2022.

(51) Int. Cl. A62C 3/07; A62C 3/06

(52) U.S. Cl. CPC A62C 3/07; A62C 3/06; A62C 33/04

(57) ABSTRACT

A fire prevention and suppression assembly includes a cylindrical body having a sidewall, with spaced arcuate slots formed in the sidewall, and threaded first and second ends. The assembly includes stabilizer feet affixed to the cylindrical body diametrically opposite the slots. An end cap is threaded onto one of the ends. The slots are positioned in a predetermined pattern that disperses water evenly across a surface. A method of preventing and suppressing fire includes coupling a water source hose to the assembly; moving the assembly underneath an electric vehicle with the slots oriented toward the undercarriage; and pressurizing the water source hose to continuously move water through the slots against the undercarriage for a selected time.

### CROSS-REFERENCE TO RELATED APPLICATION

This application claims the benefit of priority of U.S. provisional application No. 63/387,601, filed Dec. 15, 2022, the contents of which are herein incorporated by reference.

### BACKGROUND OF THE INVENTION

The present invention relates to firefighting equipment for use with electric vehicles and, more particularly, to a thermal-reducing hydraulic apparatus.

With the demand for more electric vehicles, fire departments are seeing an increase in electric car fires. The main battery is stored across the undercarriage of an electric vehicle, taking up most of the vehicle undercarriage space. When the battery is compromised, the components may heat to an extremely high temperature, causing thermal runaway, i.e., uncontrolled positive thermal feedback, which in turn may cause the car to ignite in flames long after the fire has been extinguished, even about 22 hours later.

Almost no devices are available to prevent thermal runaway in a compromised battery. One firefighting device that is commercially available is also extremely expensive and is too heavy to carry, having an approximate weight of over 140 lbs. It also takes multiple personnel and an extended period of time to set up, deploy, and maintain while in operation. This is undesirable in urgent operations.

As can be seen, there is a need for a firefighting device for use with electric vehicles and their compromised batteries that is inexpensive; easy to transport; and quick to set up, deploy, and maintain while operating with less personnel.

### SUMMARY OF THE INVENTION

In one aspect of the present invention, a fire prevention and suppression assembly comprises a cylindrical body having a sidewall and threaded first and second ends, with a plurality of spaced arcuate apertures formed in the sidewall therebetween; stabilizer feet affixed to the cylindrical body diametrically opposite the plurality of evenly spaced arcuate apertures; and an end cap threadedly coupled to one of the threaded first and second ends; wherein the plurality of spaced arcuate apertures are positioned in a predetermined pattern operative to disperse water evenly across a surface.

In another aspect of the present invention, a method of preventing and suppressing fire comprises coupling a water source hose to the fire prevention and suppression assembly; urging the fire prevention and suppression assembly underneath an electric vehicle with the plurality of spaced arcuate apertures oriented toward an undercarriage of the electric vehicle; and pressurizing the water source hose to continuously urge water through the plurality of spaced arcuate apertures against the undercarriage for a selected time.

The present invention provides a thermal-reducing hydraulic apparatus, sometimes called herein the Tactical Thermal Reducing Cylinder. The device may be slid or placed underneath an electric vehicle that is on fire, involved in a collision, or which recently had a vehicle fire extinguished, all which may have a compromised battery.

The device may be pressurized with water from a fire hose off a fire truck or fire hydrant. The device stabilizes itself underneath the vehicle and may be left without any personnel holding it or controlling it, even while pressurized and while distributing a cooling blanket of water for extended periods of time. The inventive device is light, and it is less expensive for the consumer and manufacturer. Two connections are provided; one connection serves for easy set up and deployment of the device.

This device reduces manpower, time, cost, hazardous exposure time, and risk for our fire fighters and local communities. It may improve the response time and how fire departments handle the thermal runaway, i.e., the constantly increasing temperatures of the electric car battery systems.

These and other features, aspects and advantages of the present invention will become better understood with reference to the following drawings, description, and claims.

### BRIEF DESCRIPTION OF THE DRAWINGS

FIG. 1 is a perspective view of a thermal-reducing hydraulic apparatus according to an embodiment of the present invention;

FIG. 2 is an enlarged view thereof;

FIG. 3 is another enlarged view thereof, illustrating use of a firefighter hook with the apparatus;

FIG. 4 is a front elevation view thereof;

FIG. 5 is another front elevation view thereof, shown in use position;

FIG. 6 is another front elevation view thereof, shown in use;

FIG. 7 is a sectional view thereof, taken along line 7-7 of FIG. 1; and

FIG. 8 is another sectional view thereof, shown in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a thermal-reducing hydraulic apparatus which may be used as an undercarriage battery cooling device, comprising: a slotted cylinder, stabilizing feet joined to the cylinder, and connectors coupled to each end of the cylinder. These components work together to deliver copious amounts of water over a large surface area.

The device reduces hazards and allows fire departments to make necessary decisions while the thermal-reducing hydraulic apparatus, sometimes referred to herein as the Tactical Thermal Reducing Cylinder, is deployed, reducing the temperature of the compromised battery system or other fire ground scenario where fire suppression is needed.

The cylinder houses and distributes the pressurized water coming from fire department apparatus. The cylinder is designed with fin-like angled cuts, slots, or elongated apertures, in the top of the cylinder. The angle changes as the cuts get closer to the middle of the top of the pipe, creating a fan blade pattern of water distribution in copious amounts. The length and diameter of the cylinder are not particularly limited and may be optimized or modified to accommodate different spray patterns or to be better for storage. The number of elongated apertures or slots is also not particularly limited and may be modified to accommodate various conditions. For example, the cooling device may be formed with at least 3 slots, at least 4 slots, at least 5 slots, at least 6 slots, etc. The cooling device may have up to about 15 slots, such as up to 14 slots, up to 13 slots, up to 12 slots, up to 11 slots, up to 10 slots, etc.

Stabilizing feet welded to the cylinder assist in deployment of the device and create a stable platform that prohibits the cylinder from moving while pressurized with flowing water. The dimensions of the stabilizing feet are not particularly limited. The stabilizing feet may be modified to accommodate several fire department hand tools, such as an axe, Halligan, or hook. The fire department hand tools may lock into one of the stabilizing feet, extending the reach of the firefighter to provide a safer distance between the firefighter and the compromised electric vehicle battery when deploying the device. The number of stabilizing feet is not particularly limited.

In some embodiments, the inventive tool may have a carrying handle.

To manufacture the inventive device, the manufacturer may utilize a pipe of a predetermined material having a predetermined size. For example, the pipe or cylinder may be stainless steel or steel schedule 40 pipe and may have a 2½ inch diameter and a length of about 4 feet. The pipe may be threaded at each end to accommodate 2½ inch diameter couplings. For example, the pipe may have male threads to accommodate a female coupling or may have female threads to accommodate a male coupling. The manufacturer may form slots in the pipe using a compound miter saw with a metal or graphite cutting blade or a laser cutting tool. The manufacturer may make a series of evenly spaced beveled/angled cuts into the top of the pipe and down the sides of the pipe. For example, about 13-15 cuts approximately 1.5 inches deep may be made about every 3 inches, with a straight perpendicular cut made in the center of the pipe. In some embodiments, fewer cuts may be made across a like longitudinal distance across the cylinder. Starting approximately 5 inches from a first end of the pipe, the cuts may be made having a series of angles with respect to a vertical axis, including (1) 45° (2) 40°, (3) 35°, (4) 30°, (5) 25°, (6) 22.5°, (7) 12.5°, and a central vertical cut. The angles may depend, in part, upon the number of slots formed. A mirror image pattern of cuts may be made between the center and the opposite end of the pipe. The stabilizing feet may be manufactured from stainless steel, such as ⅛″ thick steel or Schedule 40 sheet metal, cut in rectangles with dimensions of about 8 inches long by about 6 inches wide. Both ends of the sheet metal along the longitudinal axis may be rolled inward to create a cylinder, e.g., one inch in diameter, on each end, like the design of a sleigh. Two of these stabilizing feet may be welded to the bottom of the cylinder approximately 3 inches from each end of the pipe as platform stabilizers. Couplings selected for compatibility with fire department connections may be threaded onto the cylinder. National Hose (NH), National Pipe Hose Thread or National Pipe Straight Hose Thread (NPSH), or (National Pipe Thread (NPT) threads formed on both ends of the pipe allow the fire department to utilize the device, as it is compatible with NH and NPSH threaded couplings. The complete device may weigh, for example, about 35 lbs., much less than prior art devices that may weigh as much as about 120 lbs.

Fire departments that respond to electric vehicle fires or collisions may use this device as an accessory, tool, or appliance according to the following method. Two 2½ inch diameter threaded couplings may be threaded onto each end of the cylinder to make the cylinder compatible with fire department connections and apparatus. Both ends may be compatible and may be reduced to a 1¾ inch diameter coupling if needed. This allows for the flow of water from fire department apparatus or fire hydrants to the device, e.g., at 50-200 pounds per square inch (PSI). The couplings may be interchanged depending on the diameter of hose to be attached. For example, when responding to an electric vehicle fire, fire fighters may attach the cylinder to a 2½ inch or 1¾-inch inner diameter fire hose, e.g., from a fire truck, or a fire hydrant outlet, e.g., at 50 psig. Once connected to a fire hose, the device may be placed or deployed underneath the undercarriage of an electric vehicle where the vehicle battery is stored. The hose may be pressurized to continuously distribute copious amounts of water across the surface area of the undercarriage of the vehicle, including the surface area of the compromised battery, for extended periods of time. The water quickly cools the compromised electric vehicle battery for extended periods of time. Once set in place and pressurized, the device may operate without personnel to control or man it, in contrast to a prior art fire hose appliance.

The device disclosed herein may also be used while fighting a structural fire. The device may be inserted, for example, into a window. Once the device is pressurized, the ejected water causes the device to right itself, i.e., the device repositions itself with the stabilizing feet facing downward and the outlet slots facing upward.

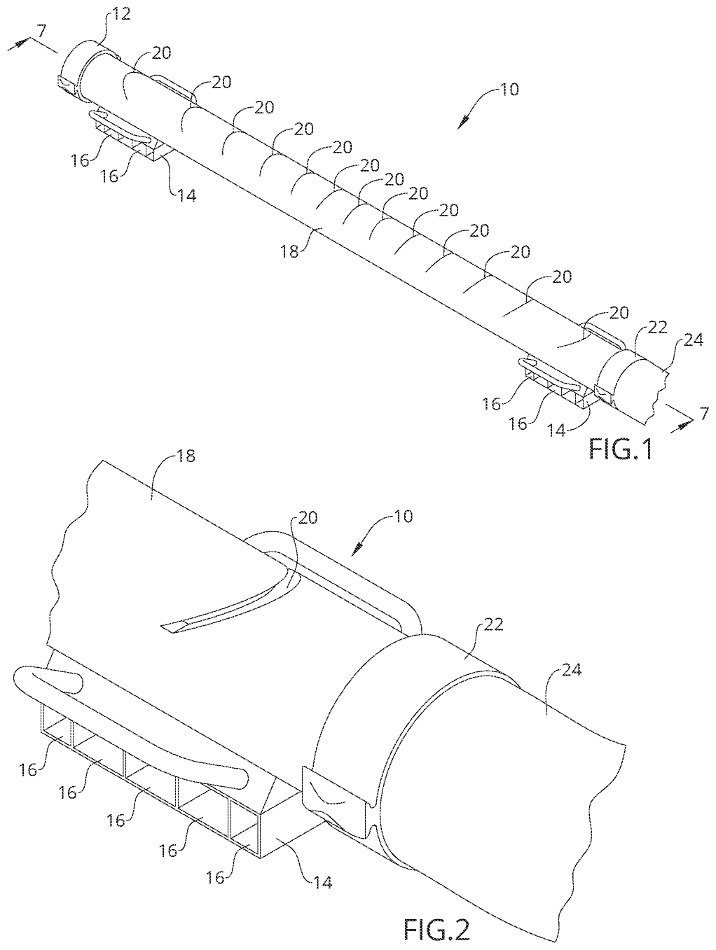

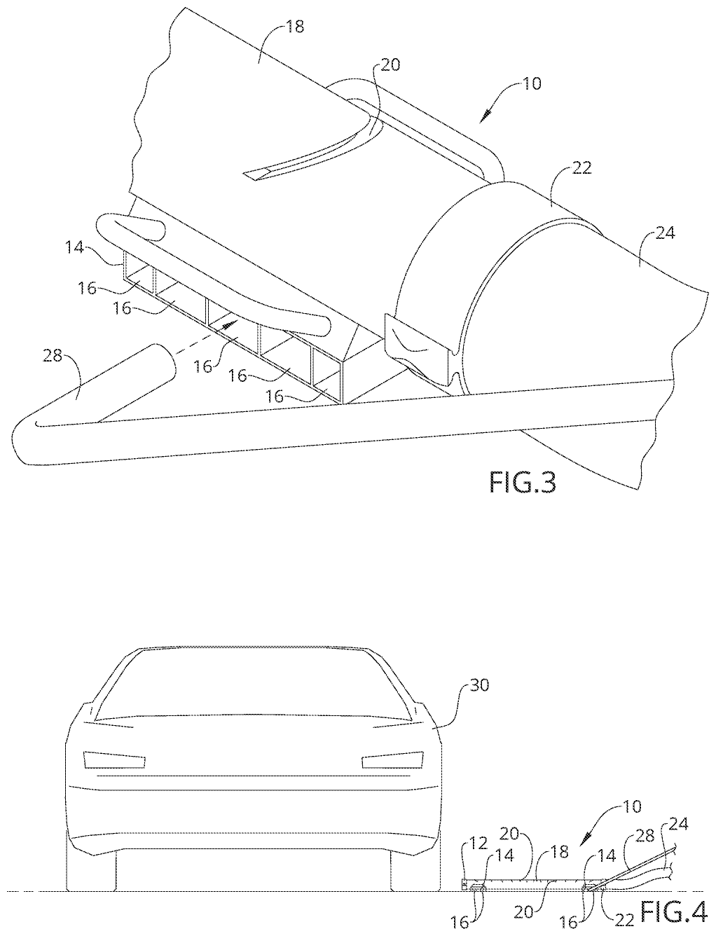

Referring to FIGS. 1 through 8, FIG. 1 illustrates a fire prevention/suppression tool assembly 10 according to an embodiment of the present invention comprising a pipe 18 having a series of slots 20 with an end cap 12 at one end and coupler 22 at an opposite direction, coupling the pipe 18 to a hose 24. The pipe 18 rests on feet 14 having feet holes 16. The coupler 22 and one of the feet 14 is shown more clearly in FIG. 2. The feet holes 16 accommodate a firefighter hook 28, as shown in FIG. 3.

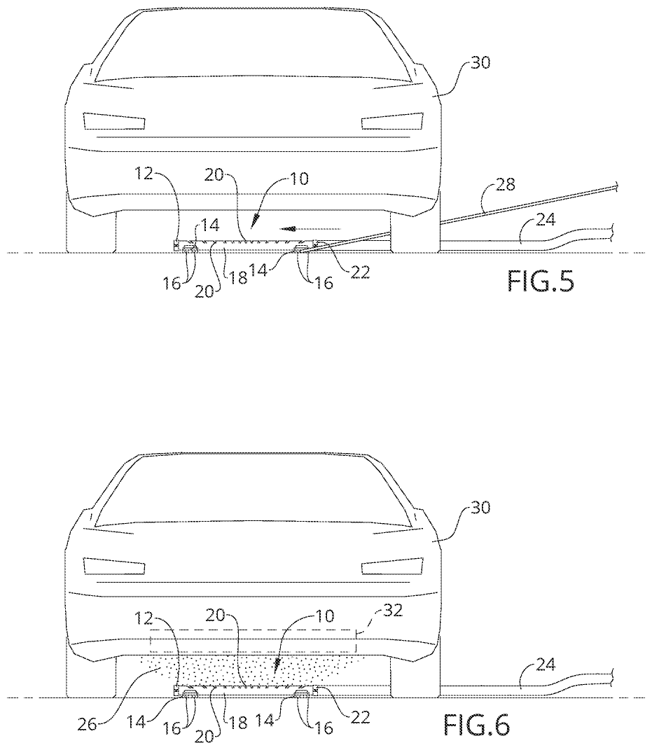

FIGS. 4 through 6 illustrate use of the assembly 10, which is placed adjacent to an electric vehicle 30, as shown in FIG. 4. Using the firefighter hook 28, the user may slide the assembly 10 underneath the electric vehicle 30 (see FIG. 5) and a water valve may be opened, pressurizing the hose 24 and driving water 26 up from the slots 20 against a battery 32, as see in FIG. 6.

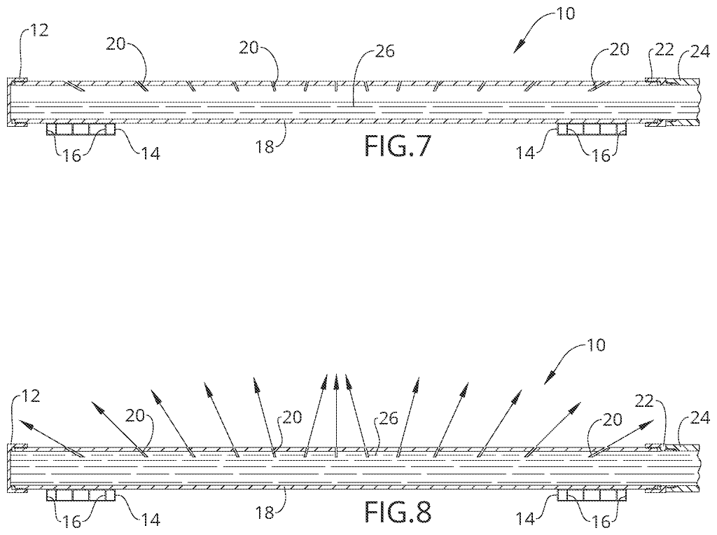

As shown in FIGS. 7 and 8, the slots 20 are provided in a predetermined pattern that disperses water 26 across the undercarriage of the electric vehicle 30 to evenly cool the battery 32.

In an embodiment, the Device is placed underneath the electric vehicle that is currently on fire, recently extinguished, or involved in a collision, with a high probability of having compromised batteries and running a high risk of generating thermal runaway. This causes extremely high temperatures inside the vehicle's battery compartment in turn, causing the vehicle to reignite hours later. This creates a significant threat/hazard to life, property, fire department personnel, communities, and citizens.

The assembly 10 of the present invention is not limited to use in the scenarios described above and may be used by fire departments to extinguish fire in multiple fire ground scenarios.

Once deployed underneath the vehicle, the device is pressurized with water from a hydrant or fire apparatus, delivering copious amounts of water to the maximum surface area of the vehicle's undercarriage, where the battery compartment is stored. Copious amounts of water are applied for an undetermined period or until the temperature of the battery is reduced.

The design creates a utility but is not limited to allowing larger quantities of water to be distributed underneath the battery compartment and disrupting and/or inhibiting thermal runaway potentiation, subsequently reducing the time it takes fire personnel to decrease temperatures in the battery compartment. The invention's light weight, low profile, and quick connect design allows fire department personnel to reduce their manpower for deployment of the device, reducing risk, hazards, time, and cost during electrical vehicle fire and collision operation.

It should be understood, of course, that the foregoing relates to exemplary embodiments of the invention and that modifications may be made without departing from the spirit and scope of the invention as set forth in the following claims.

What is claimed is:

1. A fire prevention and suppression assembly (10), comprising:
a cylindrical body (18) having a sidewall, threaded first and second ends, with a plurality of spaced arcuate apertures (20) formed in the sidewall therebetween;
stabilizer feet (14) affixed to the cylindrical body (18) diametrically opposite the plurality of evenly spaced arcuate apertures (20); and
an end cap (12) threadedly coupled to one of the threaded first and second ends;
wherein the plurality of spaced arcuate apertures (20) are positioned in a predetermined pattern operative to disperse water evenly across a surface.

2. The fire prevention and suppression assembly (10) of claim 1, wherein the plurality of spaced arcuate apertures (20) include a central, vertically oriented aperture and wherein the other of the plurality of spaced arcuate apertures are oriented at graduated angles from the central, vertically oriented aperture in both directions to a location adjacent to each of the threaded first and second ends.

3. The fire prevention and suppression assembly (10) of claim 1, further comprising a coupler (22), threadedly coupled to the other of the threaded first and second ends, operative to couple to an existing fire suppression water source.

4. The fire prevention and suppression assembly (10) of claim 1, wherein at least one of the threaded first and second ends has a diameter of between about 1¾″ and about 2½″.

5. The fire prevention and suppression assembly (10) of claim 1, said stabilizer feet (14) having lateral holes (16) formed therein operative to accommodate a firefighter tool (28).

6. The fire prevention and suppression assembly (10) of claim 1, further comprising at least one handle.

7. The fire prevention and suppression assembly (10) of claim 1, wherein the fire prevention and suppression assembly (10) is dimensioned to be accommodated under an electric vehicle undercarriage.

8. A method of preventing and suppressing fire, comprising:
coupling a water source hose (24) to the fire prevention and suppression assembly (10) of claim 1;
urging the fire prevention and suppression assembly (10) underneath an electric vehicle (30) with the plurality of spaced arcuate apertures oriented toward an undercarriage of the electric vehicle (30); and
pressurizing the water source hose (24) to continuously urge water (26) through the plurality of spaced arcuate apertures (20) against the undercarriage for a selected time.

9. The method of claim 8, wherein the step of pressurizing the water source hose comprises providing water at a pressure of at least 50 psi.

10. A method of suppressing a structural fire, comprising:
coupling a water source hose (24) to the fire prevention and suppression assembly (10) of claim 1;
inserting the fire prevention and suppression assembly (10) through a building window; and
pressurizing the water source hose (24) to continuously urge water (26) through the plurality of spaced arcuate apertures (20) into the building for a selected time.
